(19) United States
(12) Patent Application Publication
(10) Pub. No.: US 2026/0229623 A1
(43) Pub. Date: Aug. 6, 2026

(54) METHOD AND DEVICE FOR FORMING AN ELECTROCHEMICAL DEVICE

(71) Applicant: Karlsruher Institut für Technologie, Karlsruhe (DE)

(72) Inventors: Helge Stein, Karlsruhe (DE); Leon Merker, Karlsruhe (DE); Bojing Zhang, Karlsruhe (DE); Katarina Cicvaric, Karlsruhe (DE)

(73) Assignee: Karlsruher Institut für Technologie, Karlsruhe (DE)

(21) Appl. No.: 19/154,607

(22) PCT Filed: Feb. 14, 2024
(86) PCT No.: PCT/EP2024/053677

§ 371 Date: Aug. 7, 2025

(30) Foreign Application Priority Data
Feb. 15, 2023 (EP) 23156712.4

(51) Int. Cl. H01M 10/44; H01M 4/04; H01M 4/587; H01M 10/42

(52) U.S. Cl. CPC H01M 10/446; H01M 4/0447; H01M 4/587; H01M 10/4235

(57) ABSTRACT

The present invention relates to a method (210) and a device (110) for initially charging a lithium-comprising anode (114) in an electrochemical device (112), wherein the electrochemical device (112) comprises an anode (114), a cathode (116), and an electrolyte (122) configured for providing a connection between the cathode (116) and the anode (114). The method (210) comprises the following method steps: a) providing an electrochemical device (112), wherein the anode (114) and the cathode (114) have not been fully charged before; b) supplying a plurality of current pulses (126) to the electrochemical device (112), whereby a solid electrolyte interphase (30) is generated on a surface (132) of the anode (114) and on a surface (133) of the cathode (116) both adjoining the electrolyte (122), wherein the solid electrolyte interphase (130) comprises a corrosion product of the electrolyte (122) and of the anode (114) or the cathode (116), respectively; and c) obtaining the formed electrochemical device (112); d) determining at least one material parameter related to a performance of the electrochemical device (112) during method step b); and e) adjusting at least one pulse parameter related to the current pulses (126) as applied to the electrochemical device (112) during method step b). The method (210) and the device (110) according to the present invention perform the initial charging of the electrochemical device (112) in a comparatively fast manner, while scrap and spread of the electrochemical devices (112) formed in this fashion is diminished. The method (210) and the device (110) are, further, able to perform an in-situ quality control of the electrochemical device (112) during its forming in an easy, direct and reliable manner.

### FIELD OF THE INVENTION

The present invention relates to a method and a device for forming an electrochemical device.

### RELATED ART

An electrochemical device, which can also be denominated as “secondary battery” or “cell”, typically, comprises a cathode, an anode, and an electrolyte, wherein the electrolyte provides a connection between the cathode and the anode. A process of producing the electrochemical device comprises a process step of initially charging the anode within the electrochemical device, wherein the term “initially” indicates that the anode has not at all or only partially been charged before. Usually, this process step constitutes a last but rather time-consuming and cost-intensive production step of in battery manufacturing. The reason for this disadvantage can be attributed to a so-called “CCCV protocol” which is, typically, used for this purpose in lithium ion and other batteries. As generally used, the term “CCCV” relates to a constant current at a constant voltage that is applied to the lithium-comprising anode in order to charge the lithium ion battery.

Applying a constant current or a constant voltage to the electrochemical device is performed in order to generate a so-called “solid electrolyte interphase”, usually abbreviated to “SEI”, in particular, to ensure a long and safe operation of a so-charged battery. This kind of initially charging electrochemical device is usually referred to as “forming” or “formation” of the electrochemical device during which the solid electrolyte interphase is formed. Herein, the solid electrolyte interphase is generated, primarily, as a function of the constant electrical potential owing to the constant current applied to the full cell and, secondarily, as a function of the constant potential. The corrosion products that form on both the anode and the cathode constitute the solid electrolyte interphase. It in this respect, it is desired to generate the solid electrolyte interphase on a surface of the anode and cathode adjoining the electrolyte as a corrosion product of the solid electrolyte interphase and either the anode or the cathode, respectively.

However, a variety of problems can occur during the formation of the electrochemical device. Herein, the variety of problems, typically, comprises at least one of lithium plating, dendrite growth, inhomogeneous growth of the solid electrolyte interphase, or unfavorable composition of the SEI. In order to mitigate these problems, a very low value for the constant charge current, expressed as a “C-rate”, of about C/20 or less is, typically, used. Herein, the term “C/20” indicates that the electrochemical device is, fully, charged within 20 hours. As a consequence thereof, the process step of initially charging the battery remains rather slow, while scrap and spread of the electrochemical devices formed in this manner is, still, comparatively high.

US 2014/0266068 A1 discloses devices and methods to impart charge to lithium-ion battery cells. The present invention incorporates to pulse charging methods and systems related thereto that provide improvements in charging speed, efficiency and additional benefits, such as quality markers and dynamic readjustments.

U.S. Pat. No. 9,761,861 B1 discloses a battery system and an operation thereof. In an embodiment, lithium material is plated onto the anode region of a lithium secondary battery cell by a pulsed current. The pulse current may have both positive and negative polarity. One of the polarities causes lithium material to plate onto the anode region, and the opposite polarity causes lithium dendrites to be removed.

CN 109 216 806 A discloses a method for a lithium ion battery by using different current cycles at different stages and pulsed current stimulation at specific potentials, so as to fully activate the intercalation/deintercalation performance of the active material of the positive and negative electrodes, form a more dense and stable SEI film through multiple cycles of the battery under different current magnitudes, improve the stability of the positive and negative electrodes in the electrolyte, and obtain a lithium ion battery with stable performance through the formation method of the invention.

WO 2022/265187 A1 discloses a method for manufacturing a lithium secondary battery through a step-charging step of increasing the size of the charging current in stages during primary charging after primary electrolyte injection, or step-charging and pulse charging and discharging. Thereby, a SEI film can be more easily formed and the formed SEI film is stabilized, so that the gas generated in the activation process can be further reduced and the resistance of the final battery cell manufactured can be further reduced.

CN 112 820 963 A discloses a low-temperature charging method for a lithium ion battery. The method comprises the following steps: providing a three-electrode battery with a reference electrode; according to initial state parameters of the three-electrode battery, setting initial pulse current parameters, carrying out pulse charging on the three-electrode battery according to the initial pulse current parameters, the state parameters comprising at least one of the battery SOC state, the battery temperature and the battery SOH state, the pulse current parameters comprising a pulse waveform, a pulse period, a positive pulse amplitude, a negative pulse amplitude, a positive pulse duration and a negative pulse duration; and finally, in the charging process, monitoring the cathode potential and the battery voltage of the three-electrode battery in real time, and adjusting pulse current parameters according to the cathode potential and the battery voltage. According to the method, in the charging process, pulse current parameters are adjusted through the negative electrode potential and the battery voltage, so that the battery can exert the maximum charging capacity within the safety range without lithium precipitation side reaction, and safe and rapid charging of the battery is achieved.

### Problem to be Solved

It is therefore an objective of the present invention to provide a method and a device for forming an electrochemical device, which at least partially overcomes the above-mentioned problems of the state of the art.

It is a particular objective of the present invention to provide a method and a device by which an initial charging of an anode in the electrochemical device can be performed in a comparatively fast manner, while scrap and spread of the electrochemical devices formed in this fashion may be diminished.

In a further particular objective of the present invention, it would be desirable to be able to control a quality of the electrochemical device during its formation in an easy, direct and reliable manner.

### Summary of the Invention

This problem is solved by a method and a device for forming an electrochemical device having the features of the independent claims. Preferred embodiments, which might be implemented in an isolated fashion or in any arbitrary combination, are listed in the dependent claims and throughout the following description.

In a first aspect, the present invention relates to a method for forming an electrochemical device, wherein the electrochemical device comprises an anode, a cathode, and an electrolyte configured for providing a connection between the anode and the cathode. Herein, the term “cathode” refers to the positive lead of a battery, while the term “anode” refers to the negative lead. Further, the anode and the cathode are each also referred to as “electrode”. As already indicated above, the terms “forming” or “formation” of the electrochemical device refer to an initially charging of the electrochemical device, during which a solid electrolyte interphase is formed on a surface of the electrodes.

The method according to the present invention comprises the following method steps a) to c):
a) providing an electrochemical device, wherein the anode and the cathode have not been fully charged before;
b) supplying a plurality of current pulses to the electrochemical device, whereby a solid electrolyte interphase is generated on a surface of the anode and on a surface of the cathode, both surfaces adjoining the electrolyte, wherein the solid electrolyte interphase comprises a corrosion product of the electrolyte and of the anode or the cathode. respectively; and
c) obtaining the formed electrochemical device.

Herein, the indicated steps may, preferably, be performed in the given order, commencing with method step a), continuing with method step b), and completing with method step c). However, any or all of the indicated method steps a) to c) may also be repeated several times and/or preformed concurrently in part.

According to method step a), an electrochemical device is provided. As generally used, each of the terms “electrochemical device”, “secondary battery”, or “cell” refer to a device which is, after performing the present method, configured for storing and releasing electrical energy on demand. For the purposes of the present invention, the electrochemical device at least comprises an anode, a cathode, and an electrolyte, wherein the electrolyte is configured for providing a connection, especially in form of an ionic path, between the cathode and the anode. However, the electrochemical device may comprise at least one further component, in particular at least one of:
an electrolyte-soaked separator configured to spatially separating the cathode from the anode;
a cathode current collector configured for providing an electric connection to and from the cathode;
an anode current collector configured for providing an electric connection to and from the anode; or
a control device configured for controlling at least a portion of an operation of the electrochemical device.

However, using other or further components may also be feasible.

The electrochemical device may, preferably, be a lithium-ion battery; however using a further type of electrochemical device, in particular a sodium-ion battery, may also be feasible.

In a preferred embodiment, the cathode may comprise a cathode material selected from an oxide material which is capable of alloying or intercalating lithium ions. In a preferred embodiment, the cathode material may be selected from a group consisting of lithium nickel manganese oxide (LiNi_{o.5}Mn_{1.5}O₄, LNMO), a mixture of LNMO with an additional compound selected from at least one of Co, Al, and additional Li; a lithium nickel manganese cobalt oxide (LiNiₓMn_{y}Co_{z}O₂, NMC); a lithium-rich lithium nickel manganese cobalt oxide (x LiMn₂O₃·NMC, x≤0.4); lithium iron phosphate (LiFePO₄, LFP); lithium manganese phosphate (LiMnPO₄); lithium cobalt phosphate (LiCoPO₄, LCP); lithium metal phosphate (LiMPO₄), wherein M is selected from at least one of Fe, Mn, Co or Ni; lithium cobalt oxide (LiCoO₂, LCO); lithium manganese oxide (LiMn₂O₄ or Li₂MnO₃, LMO); and lithium nickel cobalt aluminum oxide (LiNi_{1-x-y}CoₓAl_{y}O₂, NCA). However, using a further kind of cathode material may also be feasible.

In a particularly preferred embodiment, the anode may a carbon-comprising anode, wherein the carbon may, preferably, be selected from graphite or hard carbon. Herein, the graphite may, preferably, be used in a lithium-ion battery, while the hard-carbon may, preferably, be used in a sodium-ion battery. As generally used, the term “graphite” refers to a well-known crystalline form of carbon comprising stacked layers of graphene, while the term “hard carbon” refers to a carbon modification which is non-graphitizable thermally.

As an alternative, the anode material can, preferably, be selected from metallic lithium, metallic sodium, or an alloying element, in particular silicon.

Further, the anode and/or the cathode may, additionally, comprise at least one additive, particularly selected from at least one of a binder or a conductive agent.

Further according to method step a), both the anode and the cathode which are comprised by the electrochemical device are a new or fresh electrode, which has not been fully charged before. In particular, the present method relates to initially charging the electrochemical device, wherein the term “initially” indicates that both the anode and the cathode have previously not been charged at all or only to a partial extent. As used herein, the term “partial extent” refers to a percentage of 20% state of charge (SoC) or less, preferably 10% state of charge (SoC) or less. In general, the anode does, especially in an uncharged state, particularly prior to step a), not comprise any lithium unless it has been brought into contact with lithium. Rather, the lithium may only be intercalated into the anode during a charging step according to method step b) as described below in more detail. However, lithium can, nevertheless, be added to the anode material, especially in form of a lithium-comprising powder of an anode material powder, before the formation of the anode according to method step a), in which event the lithium which is provided by the lithium-comprising powder can intercalate into the anode material, whereby the anode would already be charged to the partial extent as indicated above prior to performing method step a).

According to method step b), a plurality of current pulses are supplied to the electrochemical device. As a consequence thereof, on both a surface of the anode which adjoins the electrolyte and a surface of the cathode which adjoins the electrolyte a solid electrolyte interphase is generated from at least one species provided by the electrolyte and from the anode or the cathode, respectively. As already mentioned above, the term “solid electrolyte interphase”, which is usually abbreviated to “SEI”, refers to a corrosion product of at least one species of the electrolyte and of the respective electrode, which is generated in this manner on the adjacent surface of the anode or of the cathode, respectively.

In contrast to the prior art, according to which a constant electrical potential and a constant current are applied to the electrochemical device, the solid electrolyte interphase is generated here by applying a plurality of current pulses to both the anode and the cathode, which are comprised as electrodes by the electrochemical device. As generally used, the term “current pulse” refers to a temporal course of an electrical current impinging the cell, whereby a varying electrical current is provided to the electrodes, wherein the temporal course comprises, depending on a sign of the applied electrical current, an alteration of the electrical potential. Herein, an end of the pulsed formation using current pulses is, typically, defined by reaching a threshold potential. Upon reaching the threshold potential, a possibility to continue charging exists, in particular by using a constant potential or, preferred, pulsed charging by using potential pulses until a minimum current flow upon supplying a potential pulse is reached. In this event, a potential pulse may be applied during a temporal course and, subsequently, switched off, whereby the current through the electrochemical device rises and, subsequently, falls. Sign, pulse duration and pause duration between subsequent pulses may, in particular, be subject to an optimization for a specific materials arrangement comprising the anode, the cathode, and the electrolyte and, if present, the separator.

In a preferred embodiment, each current pulse can be characterized by at least one pulse parameter. As generally used, the term “pulse parameter” refers to a electrical property of each current pulse. In particular, the at least one pulse parameter may, preferably, be selected from at least one value of least one of:
a pulse duration of a current pulse;
the pause duration between at least two consecutive current pulses;
an amplitude of a current pulse; or
a sign of a current pulse.

As generally used, the term “amplitude” refers to a maximum of an intensity of a current pulse, in particular in a time interval between an onset of the electrical potential and a vanishing of the electrical potential in a single current pulse.

As further generally used, the term “sign” refers to a value which indicates whether a current pulse constitutes an increase or a decrease of a value of a current that is applied before and after the current pulse.

As further generally used, the term “pulse duration” refers to a time interval between the onset of the electrical current and the vanishing of the electrical potential in a single current pulse. Alternatively, the pulse duration may be defined by a time interval between a particularly selected value of the electrical potential or the electric current generated hereby. In particular, a full width of the pulse at half maximum (FWHM) may be used for this purpose; however, using a different value may also be feasible.

As further generally used, the term “pause duration” refers to a time interval between a vanishing of the electrical potential in a preceding current pulse and an onset of the electrical potential in a consecutive current pulse. Alternatively, the pause duration may be defined by a time interval between a particularly selected value of the respective electrical potential or the electric current generated hereby. In particular, the full width at half maximum of the preceding pulse and the full width at half maximum of the consecutive pulse may be used for this purpose; however, using a different value may also be feasible.

In a particularly preferred embodiment, the plurality of the current pulses and their respective pulse parameters may be selected to ensure a long and safe operation of the electrochemical device that is initially charged in accordance with to the present invention. Herein, the solid electrolyte interphase on the surface of the anode adjoining the electrolyte may be generated in a manner that it may particularly serve this purpose. It has been determined that it may be, particularly, advantageous to set the pulse duration of the current pulses to a value of 10 ms to 10 s, preferably of 100 ms to 5 s, more preferred of 200 ms to 2 s, in particular of 500 ms to 1 s. It has further been determined that it may be, particularly, advantageous to set the pause duration between two consecutive current pulses to a value of 10 ms to 10 s, preferably of 100 ms to 5 s, more preferred of 200 ms to 2 s, in particular of 500 ms to 1 s.

It has further been determined that the method of initially charging the anode within the electrochemical device can, advantageously, be performed within at most 10 hours, which is much shorter compared to at least 20 hours according to the state of the art. Accordingly, the plurality of the current pulses may comprise 1.800 to 1.800.000 individual current pulses, preferably 3.600 to 180.000 individual current pulses, more preferred 9.000 to 90.000 individual current pulses, in particular 18.000 to 36.000 individual current pulses.

According to method step c), the formed electrochemical device is obtaining after method step b) has been completed in an appropriate fashion. In particular, the initially charged electrodes in the electrochemical device that are formed in this manner now serve the desired purpose of ensuring a long and safe operation of the electrochemical device.

In particular, this achievement differs from the disclosure of U.S. Pat. No. 9,761,861 B1, which describes a formation of a layer of lithium metal anode on a negative current collector having very flat morphology. In this manner it is, however, not possible to generate the solid electrolyte interphase on the surface of the anode adjoining the electrolyte. Further, the electrodes in U.S. Pat. No. 9,761,861 B1 are not yet integrated into an assembled electrochemical device, whereas the method according to the present invention is performed in an already assembled electrochemical device.

Further, this achievement differs also from the disclosure of US 2014/0266068 A1, which describes devices and methods for imparting charge to a lithium ion battery cell after the cell has initially been charged, especially in order to extend their lifetime especially under fast charging conditions. As a consequence thereof, it is a prerequisite in US 2014/0266068 A1 that the cell already comprises the solid electrolyte interphase on the surface on the anode. In contrast hereto, the method according to the present invention is performed during a manufacturing of an electrochemical device at a factory site and not during a later application of the electrochemical device.

In a preferred embodiment, the present method for initially charging the lithium-comprising anode in the electrochemical device, additionally, comprises controlling a quality of the electrochemical device during its formation. For this purpose, the method may, in particular, have at last one, preferably both, of the following additional method steps:
d) determining at least one material parameter related to a performance of the electrochemical device during method step b); and
e) adjusting at least one pulse parameter related to the current pulses as applied to the electrochemical device during method step b).

According to optional method step d), at least one material parameter that is related to a performance of the electrochemical device can be determined during method step b), i.e. during the supplying of the plurality of the current pulses to the electrochemical device, whereby the solid electrolyte interphase is generated. As a consequence thereof, at least one pulse parameter which is related to the current pulses that are applied to the electrochemical device during method step b) can be adjusted according to method step e). For a definition of the term “pulse parameter” as well as for preferred examples, reference can be made to the description above and below.

In a preferred embodiment, the at least one pulse parameter related to the current pulses may be adjusted according to method step e) by using at least one value of at least one material parameter that is related to the performance of the electrochemical device. For this purpose, at least one material parameter that is related to the performance of the electrochemical device can, preferably, be determined according to method step d) from the at least one pulse parameter that is related to the current pulses as applied to the electrochemical device during method step b). As used herein, the term “performance” refers to a property of the electrochemical device which is known to be essential for a safe and long-term operation of the electrochemical device over its lifetime. As a particular result, a high performance of the electrochemical device may, particularly, comprise a diminished scrap and spread of the electrochemical devices after their production.

As further used herein, the term “material parameter” refers to a measurable value of a physical property and/or chemical property of an electrode of the electrochemical device, which can be, according to the general knowledge of the person skilled in the art, assigned to a performance of the electrode. In particular, the at least one material parameter related to the performance of the anode in the electrochemical device may, preferably, be selected from at least one of:
an internal resistance of the electrochemical device; or
a diffusion coefficient in the electrochemical device.

As generally used, the term “internal resistance” refers to a measured value of a particular electrical resistance of at least one electrically conductive body which can be attributed to a bulk property of the body, wherein a combination of the anode and the cathode acts here as the electrically conductive body in the present invention.

As further generally used, the term “diffusion coefficient” refers to a measured value that indicates an assumed linear relationship between a transport of a species and a concentration gradient of the species. According to the present invention, the species refers to the at least one species which is provided by the electrolyte to be used in generating the solid electrolyte interphase on both the anode and the cathode.

As used herein, the term “pseudo diffusion coefficient” refers to a particular kind of diffusion coefficient, which macroscopically describes a motion of the species across the electrolyte and across an interface between the electrode and the corresponding electrode. As known to the person skilled in the art, the pseudo diffusion coefficient of the anode can be determined from a gradient of an electrical potential applied to the electrochemical device. For further details and a preferred example, reference can be made to the description below.

As a result of the in-situ controlling of the quality of the electrochemical device during the forming of the electrochemical device, especially by measuring the pseudo diffusion coefficient as a function of the pulse number or a different material parameter related to the electrochemical device, the current pulses that are applied to the electrochemical device during method step b) can be, individually or as a group or a block, adjusted with regard to at least one pulse parameter in an easy, direct and reliable manner, whereby scrap and spread of the electrochemical devices formed in this fashion may considerably be diminished.

In a further aspect, the present invention relates to a device for forming an electrochemical device, wherein the electrochemical device comprises an anode, a cathode, and an electrolyte configured for providing a connection between the anode and the cathode. The device according to the present invention at least comprises:
a current supply, wherein the current supply is configured for supplying a plurality of current pulses to the electrochemical device, wherein the anode and the cathode have not more than partially been charged before; and
a control device, wherein the control device is configured for controlling the current supply to generate and supply the plurality of the current pulses to the electrochemical device in accordance with the method for forming an electrochemical device as disclosed elsewhere herein.

As generally used, the term “current supply” refers to a device which is configured for supplying an electrical current to an electrically conducting body. In accordance with the present invention, the electrical current comprises a plurality of current pulses which are applied to both the anode and the cathode, which have previously not been charged, as the body being impinged by the particular type of electrical current that is provided by the current supply.

As further generally used, the term “control device” refers to a first device which is configured for controlling a further device. As further generally used, the term “control” or any grammatical variation thereof refers to a plurality of processes comprising at least generating at least one command, forwarding the command to the further device, receiving a response from the further device upon receipt of the command, and processing the response with respect to the command. In accordance with the present invention, the control device is configured for generating a command to the current supply to generate and supply the plurality of the current pulses having at least one particular pulse parameter to the electrochemical device according to method step b). Further, the control device may, preferably, be configured for determining at least one material parameter related to the performance of the electrochemical device according to method step d), and for altering at least one pulse parameter of the current pulses applied to the electrochemical device according to method step e). Further, the control device may, be configured for performing at least one additional task.

In a further aspect, the present invention relates to computer program which, when the program is executed on a computer or a computer network, causes the computer to carry out at least method step b) of the method for forming an electrochemical device, especially by using the device for forming an electrochemical device as described elsewhere herein. Specifically, the computer program may be stored on a computer-readable data carrier and/or on a computer-readable storage medium.

In a further aspect, the present invention relates to a computer-readable storage medium. As generally used, the terms “computer-readable storage medium” and “computer-readable data carrier” refer to non-transitory data storage means, in particular a hardware storage medium having stored thereon computer-executable instructions. When the instructions are executed by the device according to the present invention, the device is caused to perform at least method step b) of the method as disclosed herein; performing at least one further method step may, however, also be feasible. The computer-readable data carrier or storage medium may, preferably, be or may comprise a storage medium, specifically, at least one of a random-access memory (RAM) a read-only memory (ROM).

For further details with respect to the device, the computer program, the computer-readable data carrier and the computer-readable storage medium, reference can be made to the description of the method as provided elsewhere herein.

With respect to the prior art, the invention as disclosed herein exhibits the following advantages. In particular, the method and the device according to the present invention are able to perform an initial charging of both the anode and the cathode in an electrochemical device in a comparatively fast manner, while scrap and spread of the electrochemical devices formed in this fashion is diminished. In a preferred embodiment, the method and the device according to the present invention are, further, able to control a quality of the electrochemical device during the initial charging of the anode and of the cathode in an easy, direct and reliable manner. Additionally, this method yields a quality marker during formation of the electrochemical device that offers dynamic readjustments of the pulse current, particularly in order to tailor the formation process of the electrochemical device for lower spread, quality, and shorter formation duration.

As used herein, the terms “have”, “comprise” or “include” or any arbitrary grammatical variations thereof are used in a non-exclusive way. Thus, these terms may refer to both a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

As further used herein, the terms “preferably”, “more preferably”, “particularly”, “more particularly”, or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in this way with other features of the invention.

### Short Description of the Figures

Further optional features and embodiments of the present invention are disclosed in more detail in the subsequent description of preferred embodiments, preferably in conjunction with the dependent claims. Therein, the respective optional features may be implemented in an isolated fashion as well as in any arbitrary feasible combination, as the skilled person will realize. It is emphasized here that the scope of the invention is not restricted by the preferred embodiments as disclosed herein.

### IN THE FIGURES

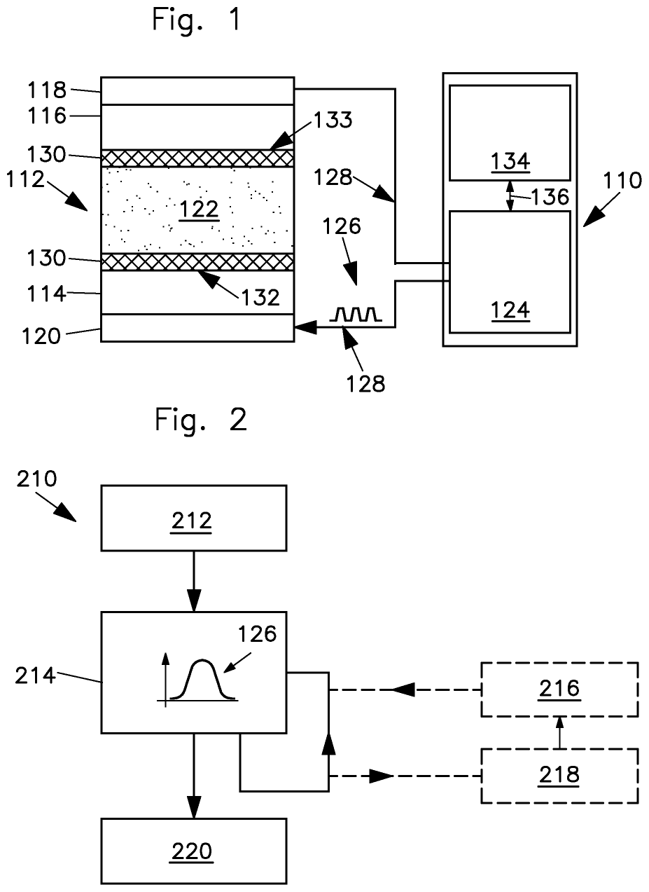

FIG. 1 schematically illustrates a device for forming an electrochemical device according to the present invention;

FIG. 2 schematically illustrates a method for forming an electrochemical device according to the present invention;

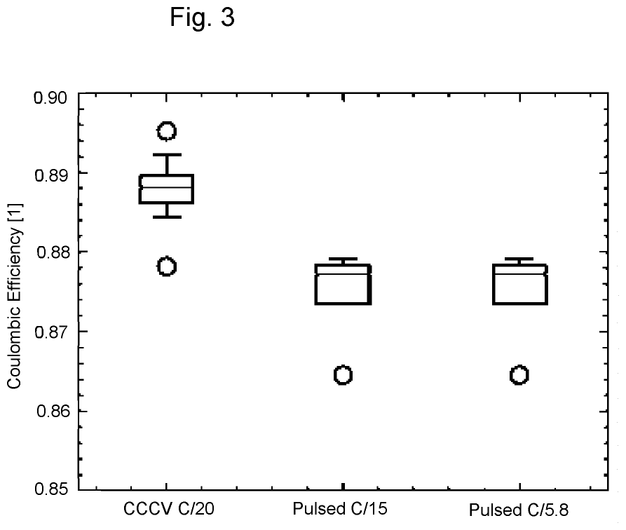

FIG. 3 illustrates measured Coulomb efficiencies of electrochemical devices in which the electrodes have been formed according to the prior art or according to the present invention;

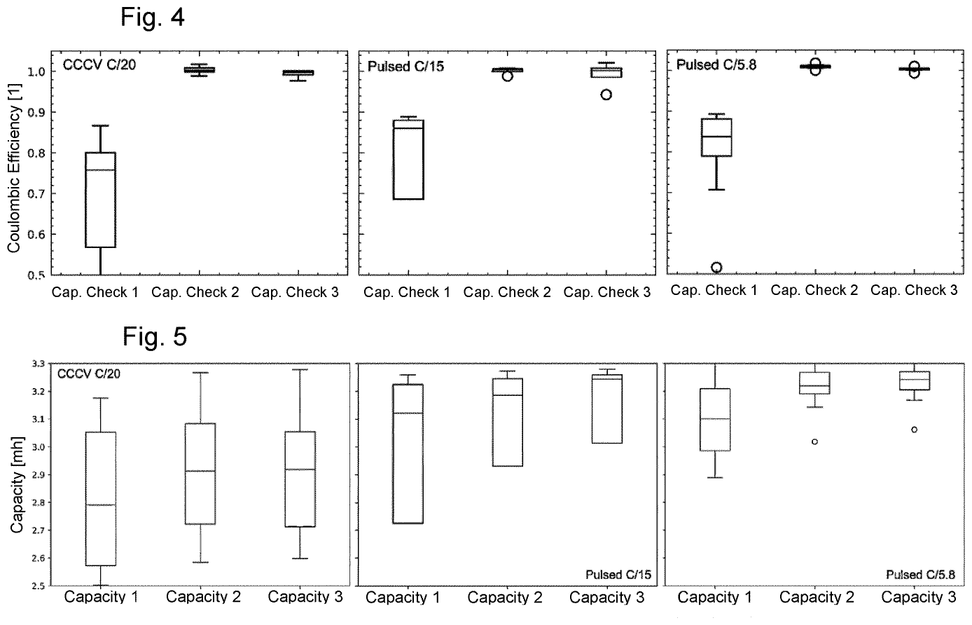

FIG. 4 illustrates Coulomb efficiencies obtained from various capacity tests of the electrochemical devices according to FIG. 3;

FIG. 5 illustrates capacities determined from the various capacity tests of the electro-chemical devices according to FIG. 4; and

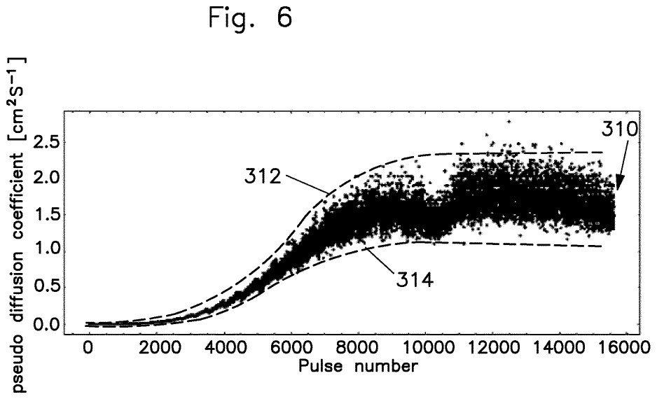

FIG. 6 illustrates a measured course of a pseudo diffusion coefficient of an electrochemical device as a function of a number of consecutive current pulses applied thereto.

### DETAILED DESCRIPTION OF THE EMBODIMENTS

FIG. 1 schematically illustrates a device 110 for forming an electrochemical device 112 according to the present invention. As depicted there, the electrochemical device 112 comprises an anode 114, a cathode 116, a cathode current collector 118 configured for providing an electric connection to and from the cathode 116, an anode current collector 120 configured for providing an electric connection to and from the anode 114 and an electrolyte 122 providing a connection between the cathode 116 and the anode 114. However, the electrochemical device 112 may still comprise further components, such as a separator (not depicted here) between the cathode 116 and the anode 114.

In accordance with the present invention, the device 110 for initially charging the lithium-comprising anode 114 in the electrochemical device 112 comprises a current supply 124. As schematically illustrated in FIG. 1, the current supply 124 is configured for generating and supplying a plurality of current pulses 126 via a connection 128 to and from the electrochemical device 112 in order to initially charge both the anode 114 and the cathode 116, which have both not been charged at all or only to a particular extent before. By supplying the plurality of the current pulses 126 to the electrochemical device 112, a solid electrolyte interphase 130 is generated on both a surface 132 of the anode and a surface 133 of the cathode, wherein both surfaces 132, 133 adjoin the electrolyte 122. As already indicated above, the solid electrolyte interphase 130 comprises a corrosion product of one or more species provided by the electrolyte 122 and of either the anode 114 or the cathode 116, respectively.

In further accordance with the present invention, the device 110 for forming the electrochemical device 112 comprises a control device 134. Herein, the control device 134 is configured for controlling the current supply 120 configured for generating and supplying the plurality of the current pulses 126 to the electrochemical device 112 in accordance with a method 210 for forming electrochemical device 112 via a bidirectional interface 136 as depicted there. In particular, the control device 134 may be configured to control one or more pulse parameters of each current pulse 126, thereby adjusting one or more electrical properties of each current pulse 126. More particular, the one or more pulse parameters may, preferably, be selected from a value of an amplitude and/or a sign and/or a pulse duration of the current pulse 126 and/or of a pause duration between two consecutive current pulses 126. However, one or more further kinds of pulse parameters may also be feasible.

In addition, the control device 134 may, preferably, be configured for determining one or more material parameters that may be related to a performance of the electrochemical device 112 and for altering one or more pulse parameters of the current pulses 126 that are applied to the electrochemical device 112. As indicated above, the performance of the electrochemical device 112 refers to a particular property of the electrochemical device 112 which is known to be essential for a safe operation of the electrochemical device 112 over its lifetime. Further, the material parameter refers to a measurable value of a physical property and/or chemical property of the electrochemical device 112 that can be assigned to the performance of the electrochemical device 112. In particular, the one or more material parameters which are related to the performance of the electrochemical device 112 in the electrochemical device 112 can, preferably, be selected from an internal resistance of the electrochemical device 112 and/or a diffusion coefficient in the electrochemical device 112; however, using one or more other material parameters may also be feasible. Further, the control device 134 may be configured for performing one or more additional tasks.

As a result of using the device 110 for forming the electrochemical device 112 according to the present invention, a diminished scrap and spread of the electrochemical devices 112 after their production can be observed, while the initial charging of both the anode 114 and the cathode 116 in the electrochemical device 112 can be performed in a comparatively fast manner, especially during 10 hours instead of at least 20 hours as known from the prior art. In the preferred embodiment as depicted in FIG. 1, the device 110 is, further, able to perform an in-situ quality control of the electrochemical device 112 during the forming of the electrochemical device 112 in an easy, direct and reliable manner, thus, further contributing to the diminished scrap and spread of the electrochemical devices 112 after their production.

FIG. 2 schematically illustrates a method 210 for forming the electrochemical device 112 according to the present invention.

In a providing step 212 according to method step a), the electrochemical device 112 is provided, wherein both the anode 114 and the cathode as comprised by the electrochemical device 112 have not at all or only to a partial extent been charged before.

In a supplying step 214 according to method step b), the current pulse 126 is supplied to the electrochemical device 112, especially by using the current supply 124. As schematically depicted in FIG. 2, the supplying step 214 is repeated for the plurality of current pulses 126. For advantageous values of the pulse duration and the pause duration between two consecutive current pulses 126, reference can be made to the description above. During the subsequent supplying steps 214, the solid electrolyte interphase 130 is generated on both the surface 132 of the anode 114 and the surface 133 of the cathode 116 which adjoin the electrolyte 122, wherein, as described above in more detail, the solid electrolyte interphase 130 comprises a corrosion product of the electrolyte 112 and of the respective electrode 114, 116.

Herein, a predefined number of current pulses 126 exhibiting one or more predefined pulse parameters can be supplied to the electrochemical device 112. However, in a preferred embodiment of the present invention, one or more pulse parameters of the current pulses 126, in particular the value of the amplitude and/or the pulse duration of the current pulse 126 and/or of the pause duration between two consecutive current pulses 126, can, individually or as a group or a block, be adjusted in an adjusting step 216 according to method step e), especially by using the control device 134, according to one or more electrical properties of each current pulse 126, which have been determined in a determining step 218 according to method step d).

In an obtaining step 216 according to method step c), the formed electrochemical device 112 is obtained as desired, in particular already after 10 hours instead of at least 20 hours as known from the prior art and with a diminished scrap and spread of the electrochemical devices 112 after their production.

For performing the method 210 according to the present invention, a computer-readable storage medium (not depicted here) may be used, wherein the computer-readable storage medium may comprise instructions which, when the instructions are executed by the device 110 cause the device 110 to perform at least the supplying step 214 as indicated above.

FIGS. 3 to 6 illustrate experimental results that have been obtained on various samples. For this purpose, lithium ion batteries have been used at a temperature of 20° C., wherein the batteries comprised NMC (a lithium nickel manganese cobalt oxide (LiNiₓMn_{y}Co_{z}O₂) and graphite as electrodes and LiPF6 as electrolyte. However, similar experimental results can be obtained by using different types of samples or temperatures as known by the person skilled in the art.

FIG. 3 illustrates measured Coulomb efficiencies of 8 electrochemical devices, in each of which the electrodes have been initially charged by using the prior art CCCV process as indicated by the term “CCCV C/20”. In addition, FIG. 3 further illustrates measured Coulomb efficiencies of further electrochemical devices, in each of which the anode has been initially charged according to the present invention, in FIG. 3 indicated by the terms “Pulsed C/ 15” for 4 electrochemical devices and “Pulsed C/ 5.8” for 8 electrochemical devices, respectively. As mentioned above, the value N=20 or 10 or 5.8 in the term “C/N” indicates an initial charging time of the respective electrochemical device.

During the initial charging of the electrochemical device, a considerable loss of lithium is, generally, observed. The indicated value of approx. 11 % (=1-89 %) for the loss of lithium in the case of using the prior art CCCV process is known from PEV1 cells. Compared hereto, the electrochemical devices, in which both the anode and the cathode have been initially charged according to the present invention, a higher value of approx. 12.5 % (=1-87.5 %) can be observed for the loss of lithium, however, independently of the initial charging time of the respective electrode.

FIG. 4 illustrates Coulomb efficiencies obtained from various capacity tests denoted by the terms “Cap. Check 1”, “Cap. Check 2”, and “Cap. Check 3” of the electrochemical devices according to FIG. 3. Further, FIG. 5 illustrates capacities denominated by the terms “Capacity 1”, “Capacity 2”, and “Capacity 3”, which have been determined from the various capacity tests denoted by the terms “Cap. Check 1”, “Cap. Check 2”, and “Cap. Check 3” of the electro-chemical devices according to FIG. 4.

Although the measured Coulomb efficiencies of electrochemical devices, in which both the anode and the cathode have been initially charged according to the present invention, are, as shown in FIG. 3, lower compared to the electrochemical devices, in which both the anode and the cathode have been initially charged by using the prior art CCCV process, they still exhibit an increased value of the capacity as indicated in FIGS. 4 and 5. As a result of this advantage, an additional formation of the electrochemical devices, in which the electrodes have been initially charged according to the present invention, can be avoided.

As can be further derived from FIG. 5, a spread of the capacity is considerably lower in electrochemical devices, in which the electrodes have been initially charged according to the present invention, compared to the electrochemical devices, in which the electrodes have been initially charged by using the prior art CCCV process.

FIG. 6 illustrates a measured course 310 of a pseudo diffusion coefficient in cm² s⁻¹ in the electrochemical device as a function of a number of consecutive current pulses applied to the electrochemical device during the initial charging of both the anode and the cathode according to the present invention. Herein, one or more values from the measured course 310 can be used for controlling the initial charging of the electrodes by comparing the one or more values to one or more predefined value, in particular taken from an upper envelope 312 and a lower envelope 314.

In other words, if a value from the measured course 310 may exceed the upper envelope 312 or may fall below the lower envelope 314, or more pulse parameters of the current pulses, in particular a value of the amplitude and/or the sign and/or the pulse duration of the current pulse and/or of the pause duration between two consecutive current pulses, can be adjusted during the adjusting step 216 as described above in more detail, thereby contributing to a diminished scrap and spread of the electrochemical devices after their production.

### LIST OF REFERENCE SIGNS

110 device for forming an electrochemical device
112 electrochemical device
114 anode
116 cathode
118 cathode current collector
120 anode current collector
122 electrolyte
124 current supply
126 current pulse
128 connection
130 solid electrolyte interphase (SEI)
132 surface (of anode)
133 surface (of cathode)
134 control device
136 (bidirectional) interface
210 method for forming an electrochemical device
212 providing step
214 supplying step
216 adjusting step
218 determining step
220 obtaining step
310 course 312 upper envelope
314 lower envelope

1. A method for forming an electrochemical device, wherein the electrochemical device comprises an anode, a cathode and an electrolyte configured for providing a connection between the anode and the cathod, the method comprising the following method steps:
a) providing an electrochemical device, wherein the anode and the cathode have not been fully charged before;
b) supplying a plurality of current pulses to the electrochemical device, whereby a solid electrolyte interphase is generated on a surface of the anode and on a surface of the cathode, both surfaces adjoining the electrolyte, wherein the solid electrolyte interphase comprises a corrosion product of the electrolyte and of the anode or the cathode, respectively;
c) obtaining the formed electrochemical device; determining at least one material parameter related to a performance of the electrochemical device during method step b); and
e) adjusting at least one pulse parameter related to the current pulses as applied to the electrochemical device during method step b).

2. The method of claim 1, wherein the at least one material parameter related to the performance of the electrochemical device is determined according to method step from the at least one pulse parameter related to the current pulses as applied to the electrochemical device during method step b).

3. The method of claim 1, wherein the at least one material parameter related to the performance of the electrochemical device is selected from at least one of:
an internal resistance of the electrochemical device;
a diffusion coefficient in the electrochemical device.

4. The method of claim 3, wherein the diffusion coefficient in the electrochemical device is a pseudo diffusion coefficient, wherein the pseudo diffusion coefficient is determined from a gradient of an electrical potential applied to the electrochemical device.

5. The method of claims claim 1, wherein the at least one pulse parameter related to the current pulses is adjusted according to method step e) by using at least one value of the at least one material parameter related to the performance of the electrochemical device

6. The method of claim 1, wherein adjusting the at least one pulse parameter related to the current pulses according to method step e) comprises altering at least one value of least one of:
the pulse duration of at least one of the pulses;
the pause duration between at least two consecutive pulses;
an amplitude of at least one of the pulses;
a sign of the at least one of the pulses.

7. A method for forming an electrochemical device wherein the electrochemical device comprises an anode a cathode and an electrolyte configured for providing a connection between the anode and the cathode, the method comprising the following method steps:
a) providing an electrochemical device, wherein the anode and the cathode have not been fully charged before;
b) supplying a plurality of current pulses to the electrochemical device whereby a solid electrolyte interphase is generated on a surface of the anode and on a surface of the cathode, both surfaces adjoining the electrolyte, wherein the solid electrolyte interphase comprises a corrosion product of the electrolyte and of the anode or the cathode, respectively;
c) obtaining the formed electrochemical device.

8. The method of claim 7, wherein the anode is a carbon-comprising anode, wherein the carbon is selected from graphite or hard carbon.

9. The method of claim 7, wherein the current pulse has a pulse duration of 10 ms to 10 s.

10. The method ngof claim 9, wherein the current pulse has the pulse duration of 100 ms to 5 s.

11. The method of claim 7, wherein two consecutive current pulses are separated by a pause having a pause duration of 10 ms to 10 s.

12. The method of claim 11, wherein the two consecutive current pulses are separated by the pause having the pause duration of 100 ms to 5 s.

13. The method of claim 7, wherein the formed electrochemical device is obtained after 10 hours or earlier.

14. A device for forming an electrochemical device, wherein the electrochemical device comprises an anode, a cathode, and an electrolyte configured for providing a connection between the anode and the cathode, the device comprising:
a current supply, wherein the current supply is configured for supplying a plurality of current pulses to the electrochemical device, wherein the anode and the cathode have not more than partially been charged before; and
a control device, wherein the control device is configured for controlling the current supply to generate and supply the plurality of the current pulses to the electrochemical device in accordance with the method for forming an electrochemical device of claim 7.

15. A computer-readable storage medium comprising instructions which, when the instructions are executed by the device claim 14, cause the device to perform at least method step b) of the method e of as claim 7.
